(19) United States
(12) Patent Application Publication
(10) Pub. No.: US 2007/0177465 A1
(43) Pub. Date: Aug. 2, 2007

(54) Display case for watches

(75) Inventor: Riccardo Rossi, Concorezzo (IT)

Correspondence Address: SHOEMAKER AND MATTARE, LTD, 10 POST OFFICE ROAD - SUITE 110, SILVER SPRING, MD, 20910, US

(73) Assignee: RK PROJECT S.R.L., Arcore (IT)

(21) Appl. No.: 10/599,040

(22) PCT Filed: Mar. 19, 2004
(86) PCT No.: PCT/IT04/00137

§ 371 Date: Oct. 26, 2006

(51) Int. Cl. G04C 1/00; G04B 3/00; G04B 5/00

(52) U.S. Cl. 368/206

(57) ABSTRACT

A display case for watches is described comprising an armoured outer case and at least one transparent portion for enabling the vision of the watches from outside. The display case further comprises supports for the watches and movement means of the supports so as to provide a preset movement to the watches in order to maintain a charge state so as to prevent stoppage.

### FIELD OF THE INVENTION

The present invention relates to a display case for watches; in greater detail it relates to a display case for watches, particularly suitable to contain mechanical self-winding watches.

### BACKGROUND OF THE INVENTION

It is known to use display cases for watches suitable to contain watches having support means for watches so as to support the watches in order to enable the vision thereof from the outside.

Watches, particularly mechanical self-winding ones, need to be kept constantly charged in order to prevent the stoppage that entails complex restarting operations and that, if prolonged, can compromise the operation of the movement mechanisms of the watches themselves.

This problem is particularly felt by the users who possess a plurality of watches and who must guarantee the continuous and simultaneous charging thereof.

### SUMMARY OF THE INVENTION

The problem of the present invention is to provide a display case for watches that resolves the drawbacks mentioned with reference to the prior art.

Such drawbacks and limitations are resolved by a display case for watches in accordance with claim 1.

Other embodiments of the display case for watches according to the invention are described in the claims below.

### BRIEF DESCRIPTION OF THE DRAWINGS

Further claims and the advantages of the present invention will be more understood from the description given below of the preferred and non-limiting embodiment examples thereof, wherein:

FIG. 1 represents a front view of a display case for watches according to the invention, wherein some parts not in view are represented with dotted lines;

FIG. 2 represents a sectional view of the display case of FIG. 1, taken along the line II-II of FIG. 1;

FIG. 3 represents a section view of the display case of FIG. 1, taken along the line III-III of FIG. 1;

FIG. 4 represents a front view of a detail of the display case of FIG. 1;

FIG. 5 represents a side view of the detail of FIG. 4 from the side of the arrow V of FIG. 4;

FIG. 6 represents an enlarged detail of FIG. 4;

FIG. 7 represents an enlarged detail of FIG. 5;

FIG. 8 represents a front view of an enlarged detail of FIG. 1;

FIG. 9 represents a front view of a support means for watches according to the invention, with a watch mounted on said support as an example;

FIG. 10 represents a section view of the support of FIG. 9, in relation to the plane X-X of FIG. 9;

FIGS. 11 and 12 represent assembly examples of the display case of FIG. 1 on relative supports.

### DETAILED DESCRIPTION OF THE INVENTION

The elements or part of the elements in common between the embodiments described below will be indicated with the same numerical references.

With reference to the abovementioned figures, 4 generally indicates a display case for watches, comprising an outer case 8, for example with a parallelepiped shape. Preferably, the outer case 8 is armoured, and is made for example, in high resistance steel alloy.

According to one embodiment, the outer case 8 has an overall parallelepiped shape, and comprises a lower wall 9, a first side wall 10, a second side wall 11, an upper wall 12 and a rear wall 13.

Said walls enclose a cavity 13′ suitable to contain watches; the cavity 13′ is open on the opposite side to the rear wall 13.

Advantageously, the outer case 8 has at least one wall 14, preferably frontal, at least in part transparent, so as to enable the vision of the content of the case itself from the outside. The wall 14 opposite the rear wall 13 constitutes a closure wall of the cavity 13′.

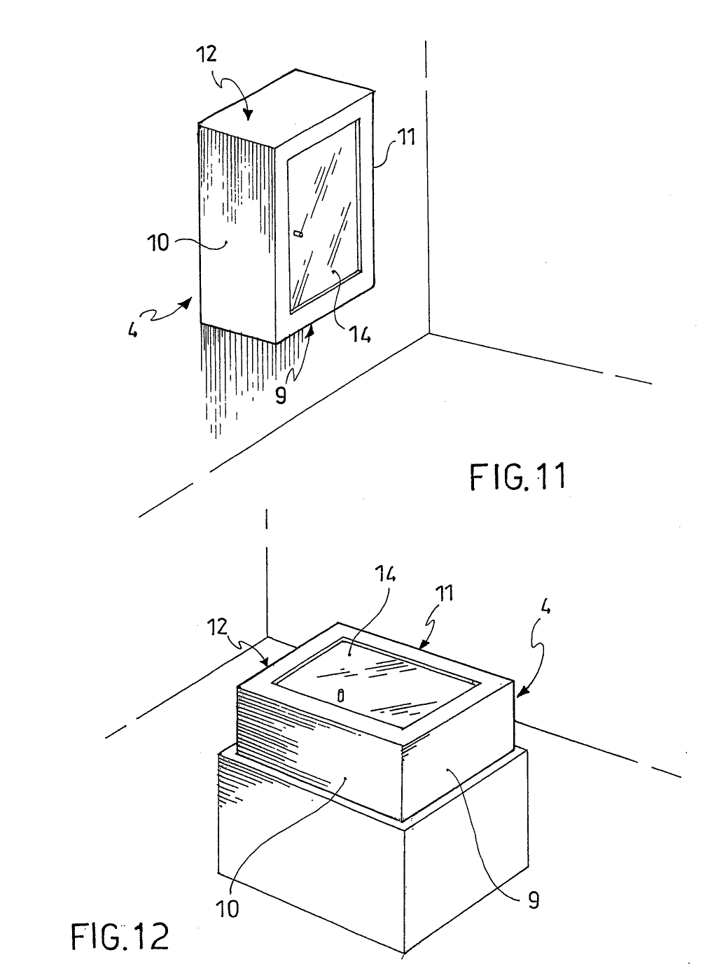

With frontal is meant that the wall 14 is arranged facing an observer/user. The display case 4 is suitable to be mounted resting with the rear wall 13 against a support, such as a wall, so that the wall 14 is arranged frontally to a user/observer, as illustrated for example in FIG. 11.

The display case can also be mounted resting the rear wall 13 against a substantially horizontal resting plane, such as illustrated in FIG. 12.

According to one embodiment, the first side wall 10, the second side wall 11, the lower wall 9 and the upper wall 12, by the side edges opposite the rear wall 13, define a frame 16. Said frame 16 may also be made on said side edges, and fixed rigidly thereto.

Preferably the frame 16 comprises a recess 17 along the side edges of the walls 9,10,11,12, said recess 17 defining a stop surface 18′, at the first side wall 10 and a hinging seat 18″, at said second side wall 11.

Said recess 17 surrounds a cavity suitable to house the wall 14.

Preferably, said wall 14 constitutes an opening/closure wing for the outer case and is of the monolithic and free-standing type.

In other words, the wall 14 supports pins 20 hinged to the outer case 8, for example at the hinging seat 18″ on the side of the second side wall 11. The pins 20 are connected to the wall 14 by brackets 21 having a ‘U’-shaped conformation so as to partially embrace a portion of wall, such as illustrated in FIG. 7. The wall 14 constitutes an opening/closure door for the outer case itself, suitable to rotate around the pins 20. In yet other words, the wall 14 is pivotally mounted in relation to the pins 20 so as to constitute an opening/closure wing for the outer case 8. The wall 14 comprises a knob 22 arranged on the opposite side to the pins 20 in order to enable the opening/closure of the wall; the knob is associated to the wall for example by gluing.

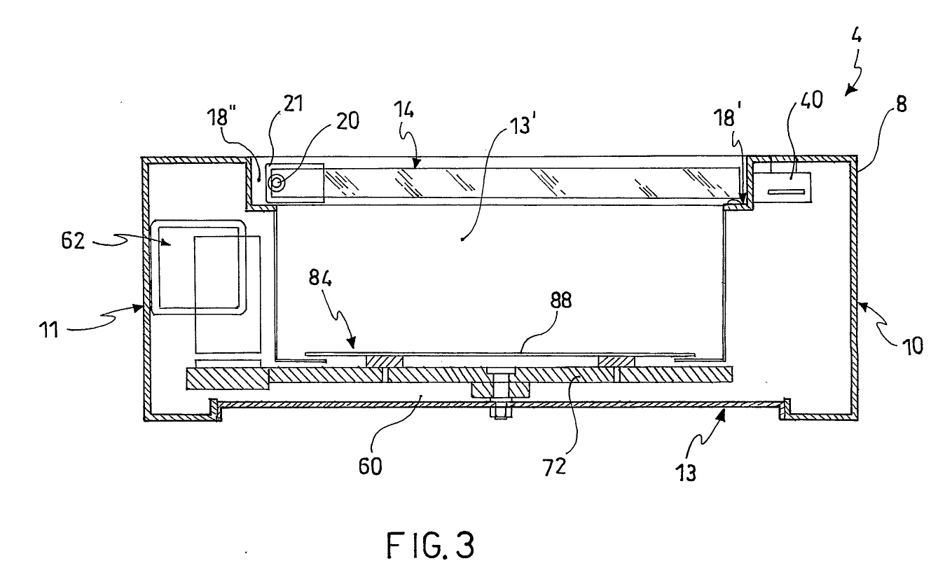

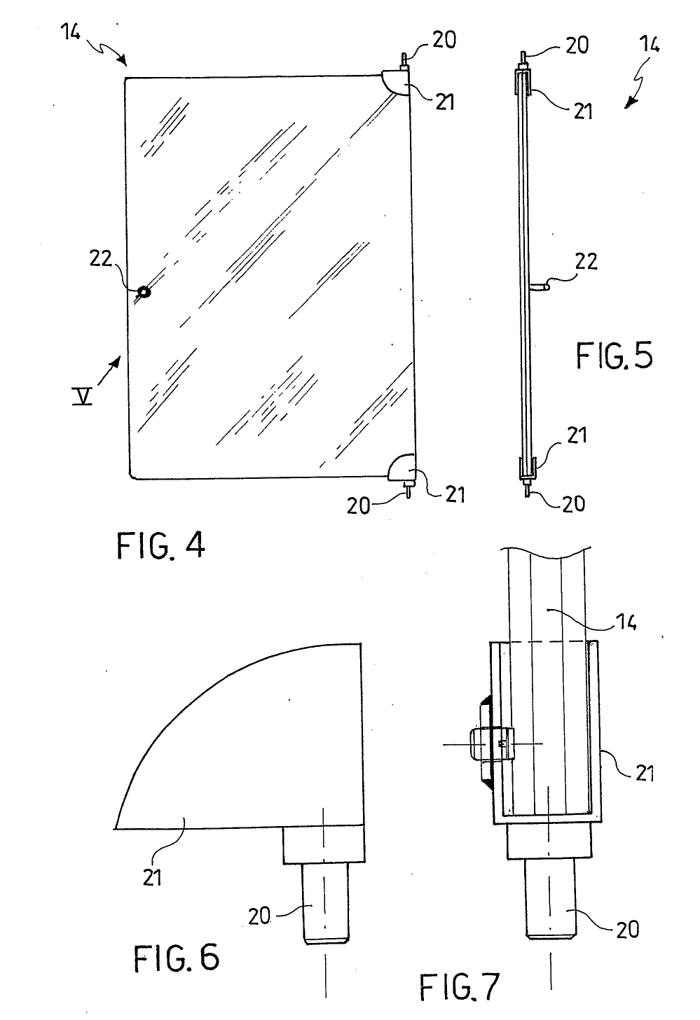

According to a preferred embodiment, the wall 14 comprises an armoured glass panel that, in a closed configuration, illustrated for example in FIG. 3, abuts against the stop surface 18′, thus arranging itself parallel to the rear wall 13.

Preferably the pins 20 are made in titanium or in an alloy containing titanium or other.

Preferably, the frame 16 is covered by a panel 28, for example counter-shaped in relation to the frame, so as to cover the frame. The panel 28 may be made in any material, for example in wood, in order to provide the desired aesthetic appearance to the outer case 8.

The frame 16, by an end opposite said pins 20, comprises a seat 32 suitable to house a lock 36, preferably armoured, in order to enable the opening and the closure of the wall 14.

According to one embodiment, the first side wall 10 houses therein securing means 40, i.e. a backplate for lock suitable to couple with the lock 36 in order to provide the fastening and the release of the wall 14.

According to an advantageous embodiment, said securing means 40 comprise transmissions 44, such as levers extending along the first side wall 10 and inside thereof, both towards the lower wall 9 and towards the upper wall 12. Rests 48 are hinged at free ends 46 of the transmissions 44.

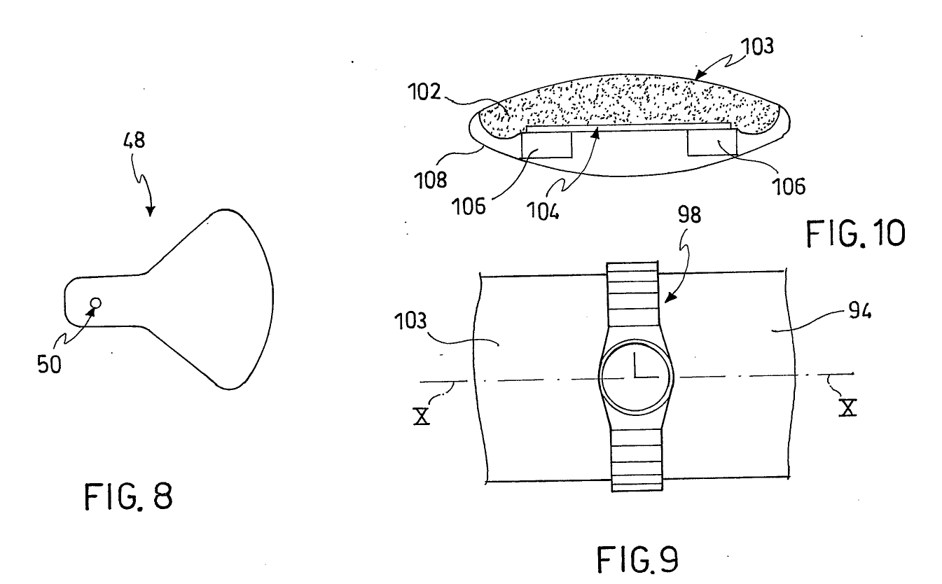

The rests 48, shown in greater detail in FIG. 8, are arranged so that in an opening position of the wall 14, i.e. of the release of the lock 36, they are hidden inside the first side wall 10, so as to not be substantially visible from the outside of the outer case 8. In the opening position they do not interfere with the wall 14, thus enabling the opening of the wall 14, i.e. the rotation of the same towards the outside.

In a lock fastening position, said rests 48 rotate so as to intercept at least one portion of the wall 14, which is thus bilaterally bound between the rests and the stop surface 18′.

Advantageously, the outer case 8 comprises movement means 60 suitable to move support means 61 for watches.

According to one embodiment, said movement means 60 comprise motor means 62, such as an electric motor and relative reduction gears terminating for example with a pinion 64. For example said motor means 62 are arranged at the second side wall 11 of the outer case 8.

The electric motor may be of the direct current type, powered by batteries housed inside the display case, or preferably of the alternating current type to which it can be connected by an electric cable passing through a suitable hole 66 made for example on the lower wall 9 of the outer case 8.

The movement means 60 comprise, for example in correspondence with the rear wall 13 of the outer case 8, at least one toothed wheel 72, made preferably in plastic or polymeric material. According to a further embodiment, said toothed wheels 72 are made in aluminium or light alloys.

According to one embodiment, a first toothed wheel 74 is pivotally mounted on the rear wall 13 in relation to an axis substantially perpendicular to the rear wall itself, so as to engage with said pinion 64 from which it receives the rotary motion.

The first toothed wheel 74 may be mechanically connected to the pinion 64 also through a belt drive.

According to one embodiment, the first toothed wheel 74 advantageously engages with a second toothed wheel 76, also pivotally mounted on the rear wall.

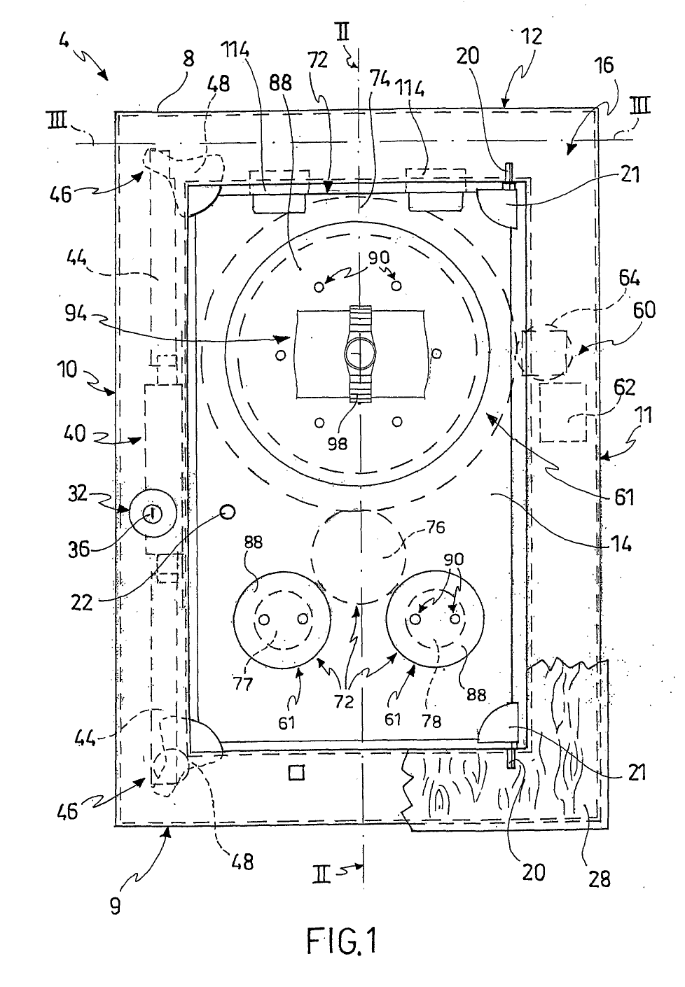

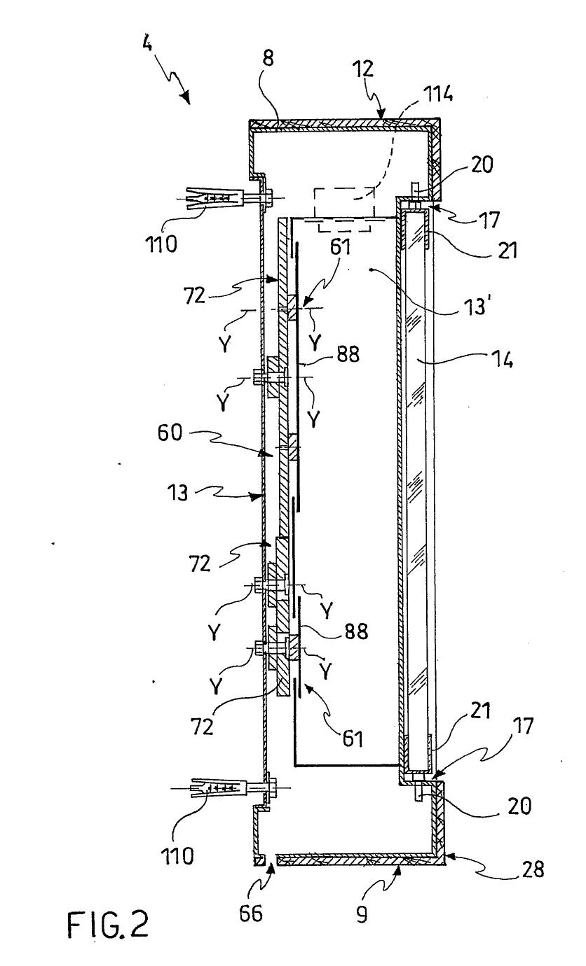

As illustrated for example in FIG. 1, the second toothed wheel engages with a third and a fourth tooth wheel 77,78 arranged for example symmetrically in relation to the second toothed wheel 76 receiving motion therefrom.

According to one embodiment, the toothed wheels 72 are all pivotally mounted in relation to axes Y parallel to one another and substantially perpendicular to the rear wall 13 or to the front wall 14.

According to further embodiments, the transmission of the motion between the toothed wheels may take place by means of the use of toothed belts.

The toothed wheels 72 can be replaced with pulleys operated through suitably pre-tensioned belts.

According to further embodiments, the wheels or pulleys may be controlled independently of one another, i.e. connected all directly to one or more conductor gears.

Advantageously the outer case 8 comprises the support means 61, suitable to support watches.

Particularly, the support means 61 comprise plates 88, such as circular rotatably integrally mounted with the toothed wheels or pulleys such as by means of screws 90.

Preferably said plates 88 are made in a ferromagnetic material.

The support means 61 further comprise watch-holder cushions 94 suitable to support a watch 98.

According to one embodiment, the watch-holder cushions 98 comprise a cushion body 102, made for example in sponge, suitable to receive in contact the bottom of a watch, in correspondence with a front face 103.

The cushion body 102, on a rear face 104, opposite to said front face 103, is connected to at least one magnetised body 106.

Advantageously, the magnetised body 106 is a unidirectional flow magnet mounted on the cushion body in order to direct the flow exclusively in the opposite sense to the front face 103.

The magnetised bodies 106 and the rear face 104 may be covered for example by a cloth 108 suitably united to the sponge.

Said watch holder cushions 94 are suitable to be mounted on the plates 88, taking the rear face 104 at least partially in contact with the plates themselves, thanks to the action of the attraction between the ferromagnetic material of the plates and the magnet bodies 106.

Advantageously a watch may be fitted around the watch-holder cushions so as to embrace the cushion with the watch strap, paying attention to position the watch bottom in correspondence with the front face 13.

According to the dimensions of the plates 88, each plate 88 may support one or more watch-holder cushions 94 with the respective watches 98.

The magnetised bodies 106 must be selected and sized, in terms of force of magnetic attraction, so as to ensure a secure fastening of the support and the watch to the relative plates.

Advantageously the outer case comprises control devices, for example a programmable logic controller (PLC), suitable to interact with the motor means 62 so as to set a precise time program of motor means activation. The control devices may also set the inversion of the direction of rotation of the motor means according to specific needs.

As illustrated for example in FIG. 11, the display case 4 is suitable to be mounted on a vertical support, such as a wall perpendicular to the floor of an environment, through for example screw anchors passing through special holes made in the rear wall of the outer case 8.

Preferably, the case is assembled in a vertical position in order to exploit the action of the force of gravity combined to the rotation action of the support means for watches, thus improving the recharging efficiency of the watches themselves.

It is also possible to arrange the outer case in a horizontal position, parallel to a resting plane of the case, such as illustrated in FIG. 12. In this configuration it is preferable to arrange the support means 61 according to a plane not parallel to the resting plane of the case, so as to exploit the action of gravity that acts particularly on the automatic watch rotor in order to perform the recharging of the same.

In other words, on the basis of the positioning of the display case according to a horizontal, vertical or inclined plane, it is possible to arrange the rotation axes Y of the support means so that they are not parallel to the direction of application of the force of gravity. One thus exploits the action of the force of gravity in order to move the charge rotor of the automatic charge mechanical watches.

Preferably, the outer case 8 comprises at least one spotlight 114, for example a low voltage halogen spotlight, suitable to internally light the case itself in order to make the watches contained therein more visible. For example the spotlights 114 can be arranged at the upper wall 12 so as to be facing the support means 61 and the watches to be lit.

The activation of the spotlights can be automatic, for example on the opening of the wall 14, or controlled by a switch.

Preferably, the security case is connected to an alarm system against break in actions.

Preferably, the activation and/or the programming of the operation of the watch movement means may selectively take place from the outside of the outer case such as by means of a control panel arranged in the vicinity of the case.

The operation of the display case for watches according to the invention will now be described.

Particularly, a user may arrange at least one watch on a relative watch-holder cushion paying attention to arrange the watch bottom in contact with the front face 103 of the cushion body 102 and the buckle of the strap on the side of the rear face 104 of the cushion body 102.

Then one applies the watch-holder cushion with the relative watch on a plate 88 taking the cloth 108 and a portion of strap into contact with the plate itself. The action of attraction between the magnet bodies and the plate in ferromagnetic material guarantees a secure fixing of the cushion-watch whole onto the support.

The activation of the motor means generates the rotation of the various plates and therefore the watches; the automatic watch rotor due to the combined action of the rotation and the force of gravity acts on the charging spring of the watches, thus ensuring a continuous condition of charging.

Preferably, the programmable logic controller activates alternate rotation phases with stoppage phases, and alternations of reverse rotations in contrary directions.

As one can appreciate from the description, the drawbacks of prior art display cases can be overcome by the described display case for watches.

Particularly, the display case for watches according to the invention makes it possible to preserve a plurality of watches in a secure manner, as they are protected by an armoured outer case.

Said outer case further enables that the watches are always well visible from the outside of the case, so as to satisfy the requirements for example of watch collectors or retailers who have the requirement of showing them to the public.

The use of a free-standing wall devoid of closure mechanisms makes it possible to increase the transparent wall surface and thus improve the visibility of the watches contained in the case.

Besides, the wall does not require framework and it thus lighter and more convenient to manoeuvre.

Besides, the display case for watches according to the invention makes it possible always to keep charged a plurality of automatic charge watches, thus preventing that the same may stop.

The stoppage of mechanical self-winding watches must be avoided as this type of watch often contains extremely complicated movements.

For example so-called astronomic self-winding watches are known that, with complex kinematism are able to indicate on the relative face for example the movements of certain planets or phases of the moon, or that have so-called perpetual calendars, able therefore to automatically indicate the exact date without requiring any manual intervention.

Such mechanisms are extremely complicated and in the case of stoppage often require restarting and phasing operations that are so complex that they can be performed by the manufacturer alone, which implies long stoppage periods and high maintenance costs.

According to a further advantage, the one-way magnetised bodies are able to ensure secure fastening of the watch-holder cushions to the relative plates, thus preventing that the cushions may accidentally fall, causing serious damage to the watches.

Thanks to the unidirectional flow of the magnets, there is no risk that the magnetic fields may influence the watches' inner mechanisms generating malfunctions or impairing the recharging of the watches themselves.

The use of magnetised bodies enables a rapid mounting and dismantling of the cushions by applying the force necessary to overcome the magnetic attraction with the relative plates, without the use of any utensil. Besides such magnetised bodies constitute bonds that are not in view and provide a pleasant appearance to the watch display case.

It is clear that variants and/or additions to that described and illustrated above can be provided.

For example the outer case may have any shape and dimension.

The wall or door 14 may be made in several parts, for example with wings or armoured shutters having a transparent portion for seeing inside the case.

The case can be arranged vertically, for example against a wall, in horizontal, or even on any inclined plane.

The plates may have any form and may rotate in relation to axes not perpendicular but inclined in relation to the rear wall, and the resting surface of the case itself.

It is possible to use as electric motors step-by-step motors suitable to generate a non continuous but jerky rotation of the watches. This rotation, especially if combined to a repeated inversion of the sense of rotation, is particularly efficient for watch winding. In fact it guarantees a considerable rotation of the watch winding rotor and is particularly efficient for mechanical watches in which the rotor is able to recharge the spring by rotating in both senses of direction.

A man skilled in the art, in order to satisfy specific and contingent requirements, will be able to make a number of modifications and variants to the display case for watches described above, all being within the scope of protection of this invention as described in the following claims.

1-13. (canceled)

14. Display case for watches comprising an outer case internally provided with support means of watches, wherein said outer case is armoured and has at least one wall at least in part transparent in order to enable vision from the outside of the watches contained therein, and that movement means of the support means are also provided in order to confer a preset movement to the watches supported.

15. The display case for watches according to claim 14, wherein said at least one wall comprises an armoured glass panel suitable to enable the vision from the outside of the watches contained in the display case.

16. The display case for watches according to claim 14, wherein said outer case comprises securing means suitable to make a fastening/releasing of the wall.

17. The display case for watches according to claim 16, wherein said securing means comprise at least one rest suitable to rotate from an opening position where it does not interfere with the wall to a closure position, in which it overlaps at least partially said wall in order to prevent the opening of the same.

18. The display case for watches according to claim 14, wherein said movement means comprise at least one motor means, suitable to activate in rotation said support means.

19. The display case for watches according to claim 18, wherein said movement means comprise at least one toothed wheel operatively connected to said motor means.

20. The display case for watches according to claim 18, wherein said movement means comprise at least one pulley operatively connected to said motor means.

21. The display case for watches according to any of the previous claims, wherein said support means comprise at least one plate rotatably integrally connected to said movement means.

22. The display case for watches according to claim 21, wherein said plates are in ferromagnetic material.

23. The display case for watches according to claim 14, wherein said support means comprise at least one watch holder cushion suitable to support a watch.

24. The display case for watches according to claim 23, wherein said watch-holder cushion comprises a cushion body suited to abut a watch bottom in correspondence with a front face of the cushion body.

25. The display case for watches according to claim 24, wherein at least one magnet body is associated to said cushion body, at a rear face opposite to said front face.

26. The display case for watches according to claim 25, wherein said magnet body is a unidirectional flow magnet, suitable to exert a magnetic attraction force in an opposite direction to said front face.
